(19) United States
(12) Patent Application Publication
(10) Pub. No.: US 2005/0168753 A1
(43) Pub. Date: Aug. 4, 2005

(54) Optical measurement of device features using interferometric illumination

(75) Inventors: Shahid Butt, Ossining, NY (US); Syed Shoaib Hasan Zaidi, Poughkeepsie, NY (US)

Correspondence Address: SLATER & MATSIL LLP, 17950 PRESTON ROAD, SUITE 1000, DALLAS, TX, 75252, US

(73) Assignee: Infineon Technologies North America Corp., San Jose, CA (US)

(21) Appl. No.: 10/771,246

(22) Filed: Feb. 3, 2004

(51) Int. Cl. G01B 9/02

(52) U.S. Cl. 356/496

(57) ABSTRACT

The properties of features formed in a substrate are measured. Interferometric illumination is used to illuminate regions of a substrate so that the features of interest occupy a greater proportion of the illuminated area. The signal-to-noise ratio of the measurement signal is therefore increased, and the sensitivity of the measurement is thus improved.

### BACKGROUND OF THE INVENTION

The present invention is directed to the fabrication of semiconductor devices and, more particularly, to the metrology of features formed during the fabrication of such semiconductor devices.

The manufacture of a semiconductor device typically requires a large number of process steps. Each process step includes one or more processing parameters that must be controlled within a relatively narrow range to obtain devices which have the desired characteristics and to obtain an acceptable yield of devices having such characteristics. In addition to controlling the conditions of each process step, the dimensions and structure of various features are determined throughout the fabrication process to ensure that the process conditions remain under control as well as to verify the calibration of various processing systems or tools. Such measurements may be carried out on control wafers, namely non-device wafers that are processed with the device wafers, or on the actual device wafers. Among the features or critical dimensions (CD) are line width, line height, sidewall angle and profile, and trench depth, as well as the presence of open or partially-opened contact windows or vias.

Advances in semiconductor processing materials and techniques have reduced the overall size of the device circuit elements or features while increasing the number of elements on a single chip. The decreased feature size and increased density have made the use of various metrology techniques more critical while also increasing the difficulty of obtaining accurate and repeatable measurements with these techniques. As an example, optical metrology systems typically use incident, scattered or reflected white or monochromatic light to illuminate the feature or structure where a measurement is taken. Such measurements are best taken, namely have the highest contrast, when the area of the feature to be measured is approximately equal to the background; i.e., the remaining area that is illuminated. However, as the features of interest have become smaller, the area of these features becomes a much smaller proportion of the total illuminated area and causes increased noise in the measurement signal, thereby reducing the sensitivity of the measurement.

Attempts to reduce the total illuminated area, so that the area of the features of interest is a greater proportion of the total illuminated area, include the use of improved lenses and/or the incorporation of apertures or pinholes. However, as the sizes of the features of interest further decrease, further reductions in the total illuminated area are needed.

It is therefore desirable to carry out such optical measurements in which the total illuminated area is further reduced with respect to the size of the features of interest.

### SUMMARY OF THE INVENTION

The present invention incorporates interferometric illumination into the optical measurement system so that the size of the total illuminated area is reduced.

In accordance with an aspect of the invention, background illumination is minimized while illuminating features formed on a substrate. At least two light beams are generated using a substantially coherent light source. A first one of the two light beams is directed onto the substrate, and a second one of the two light beams is directed onto the substrate. The first and second light beams are directed onto a common location of the substrate such that the first and second light beams interfere with each other and form a pattern of alternating light bands and dark bands on the substrate. The first and second light beams are further directed such that one of the light bands illuminates at least one region of the substrate that includes at least one feature formed on the substrate. The width of the light band and the width of the feature are substantially equal.

According to another aspect of the invention, background illumination is minimized while illuminating features formed on the substrate. Two light beams are generated using a substantially coherent light source. A first one of the two light beams is directed onto a substrate, and a second one of the two light beams is directed onto the substrate. The first and second light beams are directed onto a common location on the substrate such that the first and second light beams interfere with each other and form a pattern of alternating light bands and dark bands on the substrate. The first and second light beams are further directed such that a space in between at least two of the light bands is substantially equal to a spacing between two features formed in the substrate and such that one of the light bands illuminates a region of the substrate that includes one of the two features and another of the light bands illuminates another region of the substrate that includes another of the two features.

According to a further aspect of the invention, a property of features formed on a substrate is measured. Two light beams are generated using a substantially coherent light source. A first one of the two light beams is directed onto the substrate, and a second one of the two light beams is directed onto the substrate. A property of at least one feature is measured using light detected from the feature. The first and second light beams are directed onto a common location of the substrate such that the first and second light beams interfere with each other and form a pattern of alternating light bands and dark bands on the substrate. The first and second light beams are further directed such that one of the light bands illuminates a region of the substrate that includes the feature formed on the substrate.

In accordance with yet another aspect of the invention, an apparatus measures a property of features formed on a substrate. An interferometer generates two light beams using a substantially coherent light source and directs the two light beams onto a common location on the substrate such that the two light beams interfere with each other and form a pattern of alternating light bands and dark bands on the substrate such that one of the light bands illuminates a region of the substrate that includes at least one feature formed on the substrate. A detection system measures a property of the feature using light detected from the feature.

The foregoing aspects, features and advantages of the present invention will be further appreciated when considered with reference to the following description of the preferred embodiments and accompanying drawings.

### BRIEF DESCRIPTION OF THE DRAWINGS

FIG. 1 is a diagram showing an example of a metrology apparatus in accordance with an aspect of the invention.

FIG. 2 is a diagram showing an example of an interferometer that is incorporated into the apparatus of FIG. 1.

FIG. 3 is a diagram showing a known illumination pattern of a region of a wafer.

FIGS. 4A-4B are diagrams showing illumination patterns of a region of a wafer in accordance with aspects of the invention.

### DETAILED DESCRIPTION

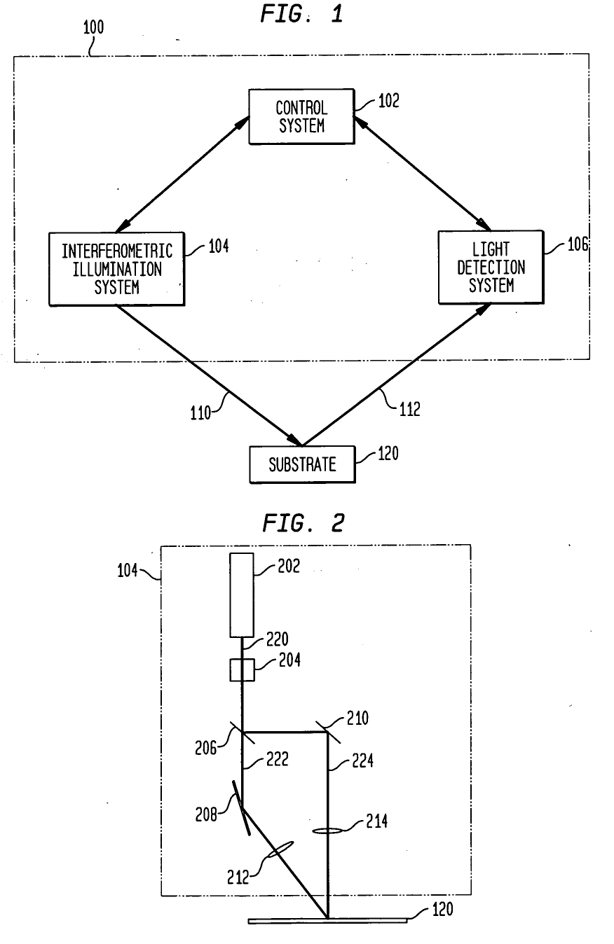

FIG. 1 illustrates a metrology system 100 of the invention that is used for obtaining data relating to the dimensions and/or structure of features formed on a substrate 120. The metrology system 100 includes a control system 102, an interferometric illumination system 104, and a light detection system 106. The illumination system 104 generates incident light 110 onto the substrate 120. The incident light 110 is in the form of two coherent light beams generated by an interferometer disposed within the illumination system 104. The illumination system 104 is configured such that the two light beams intercept at a location on the substrate 120 and interfere with each other in a manner that results in constructive interference that illuminates at least one region of the substrate 120.

The light detection system 106 detects any light 112 that is reflected or scattered off the surface of the substrate 120, generates measurement data relating to the detected light 112 and delivers the data to the control system 102. The control system 102 analyzes the data received from the light detection system 106 and delivers the data to a display (not shown) or to other output devices. The control system may also deliver the data to another processor for further analysis or to a processing tool to control part of the fabrication process based on the data. The control system 102 also controls the illumination system 104, including the optical elements disposed therein, to ensure that the two light beams interfere at the surface of the substrate 120 as well as to control the location of the region illuminated. Further, when illumination of more than one region is desired, the control system 102 also controls the optics of the illumination system 104 to adjust the spacing between the regions of constructive interference so that they illuminate the desired regions on the substrate. Such light detection systems and control systems are known in the art and comprise part of existing metrology systems as are manufactured by KLA-Tencor Corp., Leica Microsystems Wetzlar Gmbh, FEI Company etc.

FIG. 2 illustrates an example of an interferometer that forms part of the illumination system 104. A coherent light source 202, such as a laser or other coherent monochromatic or white light source, generates a light beam 220. An optical unit 204, such as a collimator or other optical element, may be included to ensure the coherency of the light generated by the light source 202. A beam splitter 206 then divides the light beam 220 into two light beams 222 and 224. Alternatively, a prism may be used in place of the beam splitter 206. The first light beam 222 is reflected by a mirror 208 such that the beam 220 passes through an objective lens 212 which focuses the beam onto the substrate 120. A further mirror 210 reflects the second light beam 224 through another objective lens 214 such that the second light beam is also focused on the substrate 120. The positions and angles of the mirrors 208, 210 and the objective lenses 212, 214 are adjustable to permit the light beams 220, 224 to intercept at a common location on the substrate 120 and to permit the difference in the optical paths of the beams 222, 224 to cause the beams to constructively interfere at a desired region of the substrate 120. The positions and angles of the mirrors 208, 210 and lenses 212, 214 may be further adjustable to control the spacings between the constructive interference pattern on the substrate such that two or more desired regions are illuminated.

The arrangement shown in FIG. 2 is merely an example of an interferometer that may be used to carry out the objectives of the invention. Additional optical elements may be incorporated into the interferometer depending on the metrology application and the measurement system. Alternatively, other interferometric arrangements known in the art may be employed in place of the arrangement shown in FIG. 2 to provide interferometric illumination on the substrate in accordance with the invention and are also dependent on the metrology application and the measurement system used.

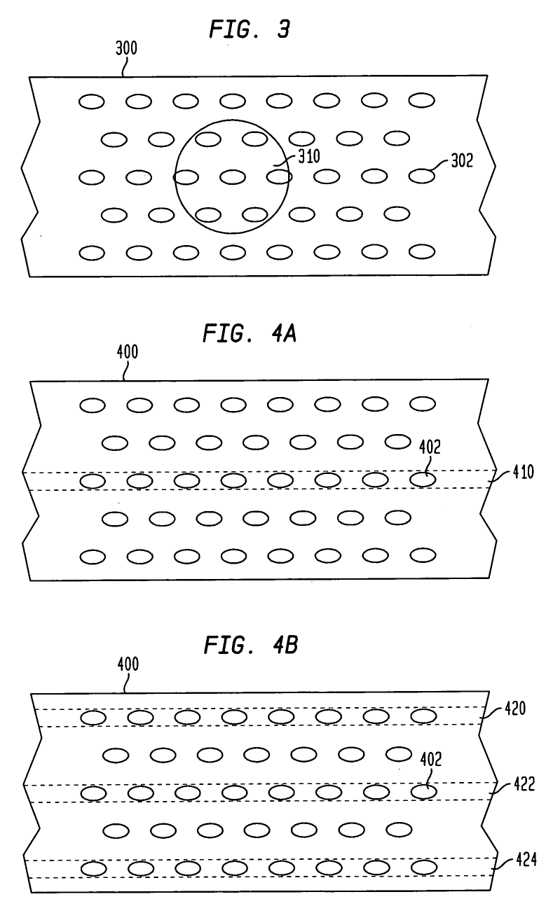

FIG. 3 illustrates an example of a substrate that is illuminated in a known manner. The substrate 300 includes a plurality of trenches 302. A circular region 310 of the substrate 300 is illuminated to permit a property of the trench located at the center of the region 310 to be measured. Because of the small size of the trenches 302, the trenches only occupy a small proportion of the total area illuminated, thereby increasing the noise present when the measurements are taken. The degraded signal-to-noise ratio reduces the sensitivity of the measurements.

The present invention improves the sensitivity of the measurements of the properties of features formed in a substrate by concentrating the light onto one or more regions of the substrate having dimensions that are much closer to those of the measured features. The amount of light that illuminates the background regions is significantly reduced so that the features of interest take up a much higher proportion of the illuminated area.

FIG. 4A illustrates an example of a region of a substrate 400 that is illuminated in accordance with an aspect of the invention. A plurality of trenches 402 are formed in the substrate 400. A small region 410 of the substrate 400 is illuminated using the interferometric illumination system 104 of the invention by arranging the optical elements of the illumination system to cause the two light beams to constructively interfere at the region 410. Preferably, when only one narrow region of the substrate is of interest, the optical elements of the illumination system are arranged so that the zero-th order interference band illuminates the region 410. Advantageously, the width of the region 410 is only slightly greater than the width of the trenches 402 so that the portion of the region 410 taken up by the trenches 402 is maximized. The light incident on the region 410 may be reflected or scattered by the features 402 within the region 410 so that a property of the trenches 402, such as the window width, profile, depth or sidewall angle may be measured.

Similarly, the invention is suitable for other types of features, such as windows, vias or line features. When such features are illuminated in the manner of the invention, other properties, such as the width or height of line features or space features, the partial opening or closing of contact windows or vias, or the photolithographic level-to-photolithographic level overlay may be measured.

Additionally, the invention is suitable for various types of measurements such as for reflectometry measurements, scatterometry measurements, critical dimension measurements, etch control measurements, etc. The invention may be used to, for example, measure line widths, line spacings, sidewall angle and/or profile, trench depth, and the presence of open or partially opened windows and vias.

FIG. 4B illustrates a further aspect of the invention in which a plurality of regions of the substrate is illuminated. The optical elements of the illumination system 104 are arranged to permit adjacent bands of constructively interfered light to illuminate the regions 420, 422, 424.

Generally, the spacing between adjacent features, such as the distance between rows of the trenches 402, are known for a particular generation of devices based on the design rules of the photolithographic masks used to print the features. Because the distance between the rows is known, the optical elements of the illumination system 104 may be arranged to provide regions of constructive interference that are separated by a spacing equal to the distance between adjacent rows of trenches or by a spacing equal to an integer multiple of the distance between adjacent rows of trenches. The optical elements of the illumination system 104 may be so arranged by adjusting the angles or locations of the mirrors or the objective lenses or by adjusting the distance between the illumination system and the substrate. As an example, the regions 420, 422, 424 are spaced to illuminate alternate rows of trenches.

The region 422 may illuminate by the zero-th order, constructive interference band, and the regions 420 and 424 are illuminated by the first order constructive interference bands. Alternatively, the region 420 is illuminated by the zero-th order constructive interference band, the region 422 is illuminated by the first order band, and the region 424 is illuminated by the second order band. The width of the illuminated regions 420, 422, 424 remain only slightly greater than the width of the trenches 402 so that the minimum amount of “background” area is illuminated.

The present invention therefore provides for the illumination of the features of interest of a substrate in which the illuminated area is minimized. As a result, the quantity of noise in relation to the measurement signal is reduced, and the sensitivity of the measurement is increased.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of minimizing background illumination while illuminating features formed on a substrate, said method comprising:
generating two light beams using a substantially coherent light source;
directing a first one of said two light beams onto said substrate; and
directing a second one of said two light beams onto of said substrate;
said first and second light beams being directed onto a common location on said substrate such that said first and second light beams interfere with each other and form a pattern of alternating light bands and dark bands on said substrate;
said first and second light beams being further directed such that one of said light bands illuminates a region of said substrate that includes at least one feature formed on said substrate;
said width of said light band and said width of said feature being substantially equal.

2. The method of claim 1 further comprising measuring a property of said feature using light detected from said feature.

3. The method of claim 1 wherein said first and second light beams are directed such that each of a plurality of said light bands illuminates a respective region of said substrate that includes at least one corresponding feature.

4. The method of claim 1 wherein said first and second light beams are further directed such that a spacing between at least two of said light bands is substantially equal to a spacing between two features formed in said substrate and such that one of said light bands illuminates a region of said substrate that includes one of said two features and another of said light bands illuminates another region of said substrate that includes another of said two features.

5. A method of minimizing background illumination while illuminating features formed on a substrate, said method comprising:
generating two light beams using a substantially coherent light source;
directing a first one of said two light beams onto said substrate; and
directing a second one of said two light beams onto of said substrate;
said first and second light beams being directed onto a common location on said substrate such that said first and second light beams interfere with each other and form a pattern of alternating light bands and dark bands on said substrate;
said first and second light beams being further directed such that a spacing between at least two of said light bands is substantially equal to a spacing between two features formed in said substrate and such that one of said light bands illuminates a region of said substrate that includes one of said two features and another of said light bands illuminates another region of said substrate that includes another of said two features.

6. The method of claim 5 further comprising measuring a property of at least one of said two features using light detected from said one feature.

7. A method of measuring a property of features formed on a substrate, said method comprising:
generating two light beams using a substantially coherent light source;
directing a first one of said two light beams onto said substrate;
directing a second one of said two light beams onto of said substrate; and
measuring a property of at least one feature using light detected from said feature;
said first and second light beams being directed onto a common location on said substrate such that said first and second light beams interfere with each other and form a pattern of alternating light bands and dark bands on said substrate;
said first and second light beams being further directed such that one of said light bands illuminates a region of said substrate that includes said feature formed on said substrate.

8. The method of claim 7 wherein said property is selected from the group consisting of: a line width, a line height, a sidewall angle, a sidewall profile, a trench depth, and a presence of an open or partially opened feature.

9. The method of claim 7 wherein said light detected from said feature is selected from the group consisting of: reflected light and scattered light.

10. The method of claim 7 wherein said width of said light band and said width of said feature are substantially equal.

11. The method of claim 7 wherein said first and second light beams are directed such that each of a plurality of said light bands illuminates a respective region of said substrate that includes at least one corresponding feature.

12. The method of claim 7 wherein said first and second light beams are further directed such that a spacing between at least two of said light bands is substantially equal to a spacing between two features formed in said substrate and such that one of said light bands illuminates a region of said substrate that includes one of said two features and another of said light bands illuminates another region of said substrate that includes another of said two features.

13. An apparatus for measuring a property of features formed on a substrate, said apparatus comprising:
an interferometer operable to generate two light beams using a substantially coherent light source and being further operable to direct said two light beams onto a common location on said substrate such that said two light beams interfere with each other and form a pattern of alternating light bands and dark bands on said substrate such that one of said light bands illuminates a region of said substrate that includes at least one feature formed on said substrate; and
a detection system operable to measure a property of said feature using light detected from said feature.

14. The apparatus of claim 13 wherein said property is selected from the group consisting of: a line width, a line height, a sidewall angle, a sidewall profile, a trench depth, and a presence of an open or partially opened feature.

15. The apparatus of claim 13 wherein said light detected from said feature is selected from the group consisting of: reflected light and scattered light.

16. The apparatus of claim 13 further comprising a control system operable to control direction of said first and second light beams.

17. The apparatus of claim 13 further comprising a control system operable to process a measured value received from said detection system.

18. The apparatus of claim 13 wherein said interferometer directs said two light beams such that said width of said light band and said width of said feature are substantially equal.

19. The apparatus of claim 13 wherein said interferometer directs said two light beams such that each of a plurality of said light bands illuminates a respective region of said substrate that includes at least one corresponding feature.

20. The apparatus of claim 13 wherein said interferometer directs said two light beams such that a spacing between at least two of said light bands is substantially equal to a spacing between two features formed in said substrate and such that one of said light bands illuminates a region of said substrate that includes one of said two features and another of said light bands illuminates another region of said substrate that includes another of said two features.
